(19) United States
(12) Patent Application Publication
(10) Pub. No.: US 2007/0008895 A1
(43) Pub. Date: Jan. 11, 2007

(54) Method and apparatus for improving centralized management of customer network sites

(75) Inventors: Kent Perkins, Antioch, CA (US); Mark Elias, Eastpointe, MI (US); Sherry Soja-Molloy, Allen Park, MI (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/174,890

(22) Filed: Jul. 5, 2005

(51) Int. Cl. H04J 1/16; H04L 12/56

(52) U.S. Cl. 370/244; 370/400

(57) ABSTRACT

A network management center (100) has a controller (102) coupled to an MPLS (Multi-protocol Label Switching) network (108) coupled to groups of customer network sites (104). The controller is programmed to provision (202) MPLS network elements to logically link the network management center with all customer network sites. Said elements are provisioned to restrict sharing of network information between groups of customer network sites. The controller is also programmed to monitor (206) customer network sites for faults therein.

### FIELD OF THE INVENTION

This invention relates generally to network management systems, and more particularly to a method and apparatus for improving centralized management of customer network sites.

### BACKGROUND OF THE INVENTION

Frequently, service providers of telecommunication networks are hired by mid-to-large size corporations to manage and maintain network elements at one or more private communication network sites owned by these corporations for on-going business activities. Service providers have used several techniques to tap into these networks for management purposes.

For instance, some service providers have interconnected a fixed communication link such as a T1 line between the service provider's management system and a hub or transit point of the customer's network to acquire visibility to network elements of the enterprise, thereby providing a means for monitoring faults. Fixed communication links, however, are costly and problematic when either the fixed link or the hub connected thereto experiences a fault, which in turn can eliminate visibility into the customer's network altogether. To mitigate this issue, redundant fixed links can be employed at several locations of the customer's networks. This approach, however, remains costly.

To reduce cost, service providers have used PVCs (Permanent Virtual Circuits) in FR (Frame Relay) and/or ATM (Asynchronous Transfer Mode) networks for end-to-end connectivity between customer premise equipment and the service provider's management system. PVCs are software-defined logical connections in an FR/ATM network which provide the service provider a highly flexible network technology for dynamically interconnecting to customer premise equipment. Although this technique can reduce the cost of fixed lines, scalability, logistics, and security remain a concern.

As more PVCs are installed to support large customers with many communication network sites located in expansive geographic regions such as the United States and overseas, scalability and logistics for maintaining these logical links can become daunting and difficult to manage. Additionally, CE (Customer Edge) and PE (Provider Edge) routers coupled to private customer networks are programmed to advertise routing information throughout the FR/ATM network which poses security issues for a customer who's networks can be impacted by intruders or hackers seeking to steal or destroy information as a form of cyber-terrorism.

A need therefore arises for a method and apparatus to improve centralized management by service providers of customer network sites.

### SUMMARY OF THE INVENTION

Embodiments in accordance with the invention provide a method and apparatus for centralized management of customer network sites.

In a first embodiment of the present invention, a network management center has a controller coupled to an MPLS (Multi-protocol Label Switching) network coupled to groups of customer network sites. The controller is programmed to provision MPLS network elements to logically link the network management center with all customer network sites, wherein said elements are provisioned to restrict sharing of network information between groups of customer network sites, and monitor customer network sites for faults therein.

In a second embodiment of the present invention, a network management center operates according to a method having the steps of provisioning MPLS network elements to logically link the network management center with all customer network sites, wherein said elements are provisioned to restrict sharing of network information between groups of customer network sites, and monitoring customer network sites for faults therein.

In a third embodiment of the present invention, a computer-readable storage medium operates in a network management center having computer instructions for provisioning MPLS network elements to logically link the network management center with all customer network sites, wherein said elements are provisioned to restrict sharing of network information between groups of customer network sites, and monitoring customer network sites for faults therein.

### BRIEF DESCRIPTION OF THE DRAWINGS

FIG. 1 is block diagram of an NMC (Network Management Center) according to an embodiment of the present invention;

FIG. 2 is block diagram of CE (Customer Edge) routers operating with routing targets configured by NMC according to an embodiment of the present invention; and

FIG. 3 depicts a flowchart of a method operating in the NMC according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

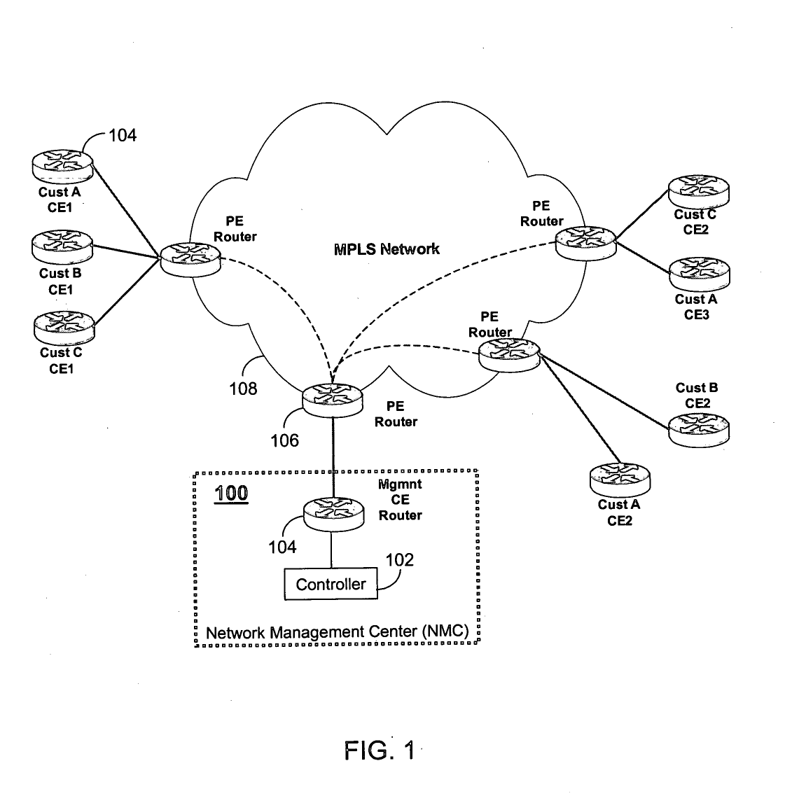

FIG. 1 is block diagram of an NMC (Network Management Center) 100 according to an embodiment of the present invention. The NMC 100 comprises a controller 102 coupled to a conventional CE (Customer Edge) router 104. The NMC 100 monitors the operations of customer network sites and is programmed to take mitigation steps when a fault is detected in one or more of said sites. Customer network sites can comprise mid-to-large customer networks that interconnect employees, supplies, or other agents of the customer. These networks can be packet switch and/or circuit switch networks depending on the needs of the customer.

Additionally, a customer's network can span several sites at disparate geographic locations. For instance, in FIG. 1 Customer A may have three sites which are accessible by the NMC 100 by way of three CEs (Customer A: CE 1, CE 2 and CE 3). The NMC 100 can access these CEs by way of PEs (Provider Edge) routers 106 coupled thereto. The NMC 100 can access the PEs by way of logical links 110 configured by the NMC 100 in an MPLS (Multi-protocol Label Switching) network 108.

In the present illustration, the NMC 100 manages three customers (Customers A, B and C), each having three network sites interconnected to PEs 106 by way of local CEs 104. The controller 102 utilizes conventional technology for performing the task of managing network elements of customer sites. Any conventional computing technology (such as a server) can be utilized by the present invention. Additionally, any conventional software application (such as a Customer Relations Management application, telemetry applications, fault detection applications, etc.) can be applied to the present invention. It would be obvious to one of ordinary skill in the art that the NMC 100 as described herein is scalable so as to support more or less customer network sites than is shown in FIG. 1 without departing from the scope of the claimed invention.

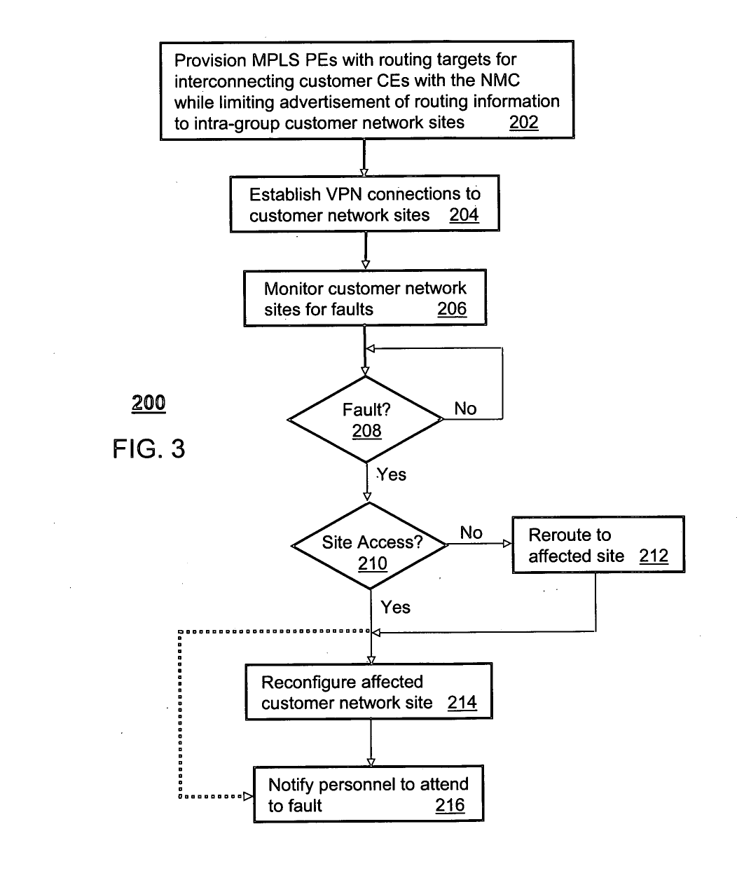

FIG. 3 depicts a flowchart of a method 200 operating in the NMC 100 according to an embodiment of the present invention. Method 200 begins with step 202 where the NMC 100 is programmed to provision the MPLS PEs 106 with routing targets for interconnecting customer CEs 104 with the NMC 100. The routing targets are configured so as to restrict sharing of network information between Customers A, B and C. The NMC 100 accomplishes this by provisioning the PEs 106 so that routing information is not advertised between Customers A, B, and C.

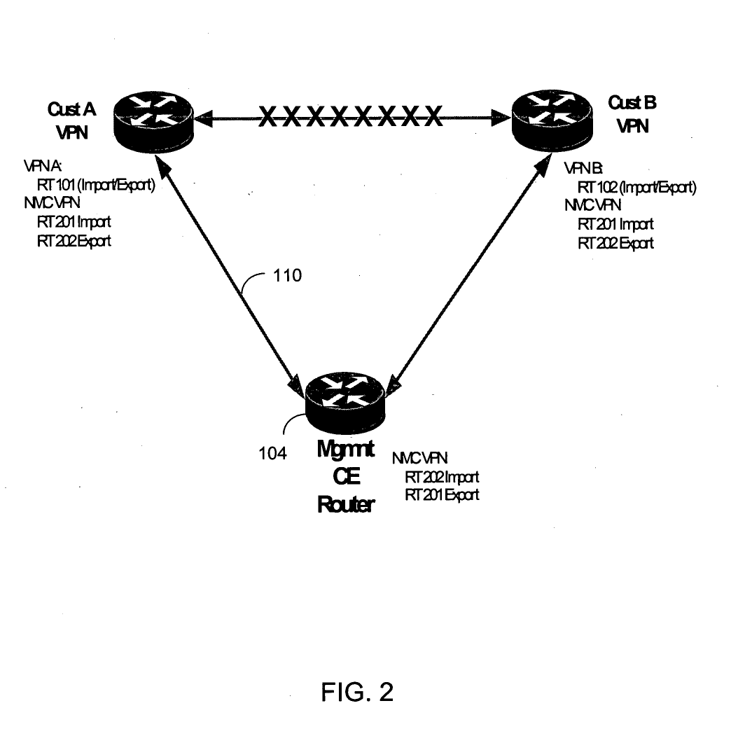

An example of routing targets 110 with the foregoing restriction is illustrated for Customers A and B in FIG. 2 in accordance with an embodiment of the present invention. In this illustration, the NMC 100 has an import routing target 202, and an export routing target 201. The routing target designations 201 and 202 are only for illustration purposes; thus, any designation is possible. Customer A has a bidirectional (i.e., import/export) routing target 101, an NMC import routing target 201, and an NMC export routing target 202. Customer B, on the other hand, has a bidirectional routing target 102, with the same NMC import and export routing targets (i.e., 201 and 202) of Customer A.

From these routing targets, the NMC 100 can receive information from Customers A or B at its import routing target 202, or transmit information to Customers A or B at its import routing target 201. Routing target 101, on the other hand, can be used by Customer A to bidirectionally communicate from a CE 104 of one site of Customer A to another. That is, each of CEs 1, 2 and 3 of Customer A have a bidirectional routing target 101, which allows them to intercommunicate privately. The same is true for Customer B with respect to the bidirectional routing target 102.

From this model of routing targets, the NMC 100 can privately manage each of Customers A, B or C's network sites (i.e., CE 1, CE 2 or CE 3). Additionally, each of Customers A, B and C can intra communicate, but cannot intercommunicate as illustrated by the crossed out link shown between Customer A and Customer B in FIG. 2. This is because the PEs 106 are provisioned so that the routing information relating to the routing targets just described is not advertised between customers. Routing information is only known between the NMC 100, the customers it services, and by intra-group customer network sites (e.g.,, Customer A: CE1 knows routing information for CE 2 and CE 3, CE 2 knows routing information for CE 1 and CE 3, and CE 3 knows routing information for CE 1 and CE 2). There is no sharing of routing information between customers, thus preventing as security breach by inter-customer intruders.

Referring back to FIG. 3, in step 204, the NMC 100 establishes the logical links between the NMC and each customer network site as VPNs (Virtual Private Networks) to further increase security. Once the VPN links have been established, the NMC 100 begins to monitor in step 206 each customer network site for faults. Faults can be monitored by any conventional means existing today or evolving in the future. For example, the NMC 100 can be programmed to send test packets that hop between nodes of each customer network site to gather telemetry information. From this telemetry information, the NMC 100 can be programmed to define faults in any manner suitable for properly managing a customer network site.

If in step no faults are detected, the NMC 100 continues to perform the monitoring operations just described. If, on the other hand, a fault is detected, the NMC 100 can determine in step 210 if said fault has prevented access to the affected customer network site (e.g., CE 1 of Customer A breaks down and the NMC 100 can no longer access network elements in this site). If access has been prevented, the NMC 100 can be programmed to seek access to the affected site by way of an unaffected site of the same customer if such connectivity is available.

If access to the affected site is available, then the NMC 100 proceeds to step 214 where it reconfigures the affected customer network site. This step can represent, for example, detecting a failure in a network node of the affected site, thereafter disabling said note and reconfiguring the topology of the affected customer network site to minimize the impact of communications resources used by employees or agents of said customer site. In a less sophisticated embodiment, the NMC 100 can be programmed in step 216 to notify personnel (its own, contracted parties, and/or employees of the affected customer) to attend to the affected site. The notification can be supplied by way of an email or a wireless message containing fault information that can be used for diagnostic purposes.

It should be evident by now that the present invention can be realized in hardware, software, or a combination of hardware and software. Moreover, the present invention can be realized in a centralized fashion, or in a distributed fashion where different elements are spread across several interconnected processors. Thus, any kind of computing device or other apparatus adapted for carrying out method 200 described above is suitable for the present invention.

It should be also evident that the present invention may be used for many applications. Thus, although the description is made for particular arrangements and methods, the intent and concept of the invention is suitable and applicable to other arrangements and applications not described herein. For example, method 200 can be reduced to steps 202 and 206 consistent with the claimed invention. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

A software program in the present context means any expression, in any language, code or notation, of a set of instructions intended to cause a system having an information processing capability to perform a particular function either directly or after either or both of the following: a) conversion to another language, code or notation; b) reproduction in a different material form.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art that are applicable to the present invention. Such standards are periodically superseded by faster or more efficient equivalents having essentially the same functions. Accordingly, replacement standards and protocols having the same functions are considered equivalents.

The described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A network management center, comprising:
a controller coupled to an MPLS (Multi-protocol Label Switching) network coupled to groups of customer network sites, wherein the controller is programmed to:
provision MPLS network elements to logically link the network management center with all customer network sites, wherein said elements are provisioned to restrict sharing of network information between groups of customer network sites; and
monitor customer network sites for faults therein.

2. The network management center of claim 1, wherein the MPLS network elements comprise a plurality of PEs (Provider Edges) each coupled to one or more CEs (Customer Edges) supporting a customer network site, wherein the controller is programmed to provision each PE to establish said logical links with restricted network information sharing.

3. The network management center of claim 2, wherein the controller is programmed to provision each PE to limit advertisement of routing information to intra-group customer network sites and the network management center.

4. The network management center of claim 1, wherein the logical links comprise import and export routing targets with routing information limited to intra-group customer network sites and the network management center.

5. The network management center of claim 1, wherein the logical links comprise VPN (Virtual Private Network) links.

6. The network management center of claim 1, wherein the controller is programmed to:
detect a fault at a customer network site; and
take evasive action to mitigate fault.

7. The network management center of claim 6, wherein the fault prevents access to the customer network site, and wherein the evasive action step comprises the step of accessing the affected customer network site from an intra-group customer network site coupled thereto.

8. The network management center of claim 6, wherein the fault is detected at a network element of the affected customer network site, and wherein the evasive action step comprises at least one among a group of mitigation steps comprising reconfiguring the affected customer network site to minimize customer use impact, and notifying personnel to attend to the faulted network element.

9. In a network management center, a method comprising the steps of:
provisioning MPLS network elements to logically link the network management center with all customer network sites, wherein said elements are provisioned to restrict sharing of network information between groups of customer network sites; and
monitoring customer network sites for faults therein.

10. The method of claim 9, wherein the MPLS network elements comprise a plurality of PEs (Provider Edges) each coupled to one or more CEs (Customer Edges) supporting a customer network site, wherein the method comprises the step of provisioning each PE to establish said logical links with restricted network information sharing.

11. The method of claim 10, comprising the step of provisioning each PE to limit advertisement of routing information to intra-group customer network sites and the network management center.

12. The method of claim 9, wherein the logical links comprise import and export routing targets with routing information limited to intra-group customer network sites and the network management center.

13. The method of claim 9, wherein the logical links comprise VPN (Virtual Private Network) links.

14. The method of claim 9, comprising the steps of:
detecting a fault at a customer network site; and
taking evasive action to mitigate fault.

15. The method of claim 14, wherein the fault prevents access to the customer network site, and wherein the evasive action step comprises the step of accessing the affected customer network site from an intra-group customer network site coupled thereto.

16. The method of claim 14, wherein the fault is detected at a network element of the affected customer network site, and wherein the evasive action step comprises at least one among a group of mitigation steps comprising reconfiguring the affected customer network site to minimize customer use impact, and notifying personnel to attend to the faulted network element.

17. A computer-readable storage medium in a network management center, the storage medium comprising computer instructions for:
provisioning MPLS network elements to logically link the network management center with all customer network sites, wherein said elements are provisioned to restrict sharing of network information between groups of customer network sites; and
monitoring customer network sites for faults therein.

18. The storage medium of claim 17, wherein the MPLS network elements comprise a plurality of PEs (Provider Edges) each coupled to one or more CEs (Customer Edges) supporting a customer network site, wherein the storage medium comprises computer instructions for provisioning each PE to establish said logical links with restricted network information sharing.

19. The storage medium of claim 18, wherein the logical links comprise import and export routing targets, and wherein the storage medium comprises computer instructions for:
provisioning each CE with said routing targets; and
provisioning each PE with limiting advertisement of routing information to intra-group customer network sites and the network management center.

20. The storage medium of claim 8, comprising computer instructions for:
detecting a fault at a customer network site; and
taking evasive action to mitigate fault.
